(19) United States
(12) Patent Application Publication
(10) Pub. No.: US 2007/0254169 A1
(43) Pub. Date: Nov. 1, 2007

(54) Structures including organic self-assembled monolayers and methods of making the structures

(76) Inventors: Theodore I. Kamins, Palo Alto, CA (US); Douglas A.A. Ohlberg, Palo Alto, CA (US); Amir A. Yasseri, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/412,839

(22) Filed: Apr. 28, 2006

(51) Int. Cl. B32B 3/00; B32B 7/00; B05D 3/00

(52) U.S. Cl. 428/447; 428/448; 428/333

(57) ABSTRACT

Structures including a substrate having a nano-patterned surface, and a self-assembled monolayer of an organic material on the nano-patterned surface are provided. The self-assembled monolayer is ordered with respect to features of the nano-patterned surface. Methods of making the structures and filament switching devices including a self-assembled monolayer are also provided.

### STATEMENT REGARDING FEDERALLY SPONSORED RESEARCH OR DEVELOPMENT

At least some aspects of this invention were made with Government support under contract numbers N6601-04-1-8916 and HR0011-05-3-0001. The Government may have certain rights in this invention.

### BACKGROUND

Self-assembled monolayers (SAMs) of amphiphillic molecules have been used as films in structures for tuning the chemical characteristics of metal and semiconductor surfaces. Certain chemical precursors have been investigated experimentally and determined to form self-assembled monolayers and Langmuir-Blodgett (LB) monolayer films on surfaces. For example, these precursors have been used to form limited-size domains on certain surfaces; the size of domains in self-assembled monolayers is especially limited. These limited-size domains are unsatisfactory for applications that require greater long-range ordering of the molecules forming the layers.

### SUMMARY

An exemplary embodiment of a structure including a self-assembled monolayer comprises a substrate including a nano-patterned surface; and a self-assembled monolayer of an organic material on the nano-patterned surface, wherein the self-assembled monolayer is ordered with respect to features of the nano-patterned surface.

An exemplary embodiment of a filament switching device comprises a lower electrode having a nano-patterned surface; a self-assembled monolayer of an organic material formed on the nano-patterned surface, wherein the self-assembled monolayer is ordered with respect to features of the nano-patterned surface; and an upper electrode formed on the self-assembled monolayer.

An exemplary embodiment of a method of making a structure including a self-assembled monolayer is provided, which comprises forming a self-assembled monolayer of an organic material on a nano-patterned surface of a substrate, wherein the self-assembled monolayer is ordered with respect to features of the nano-patterned surface.

### BRIEF DESCRIPTION OF THE DRAWINGS

FIG. 1 is a top plan view of a structure including an organic self-assembled monolayer having domains formed randomly on an unpatterned surface of a substrate.

FIG. 2 is a transverse cross-section of the structure shown in FIG. 1.

FIG. 3 is a top plan view of the structure after further lateral expansion of the domains on the unpatterned surface of the substrate, which shows multiple domains separated from each other by random domain boundaries.

FIG. 4 is a transverse cross-section of the structure shown in FIG. 3.

FIG. 5 is a top plan view of an exemplary embodiment of a substrate having a nano-patterned surface.

FIG. 6 is a transverse cross-section of the substrate shown in FIG. 5.

FIG. 7 is a top plan view of an exemplary embodiment of a structure comprising the substrate shown in FIG. 5 and an organic self-assembled monolayer formed initially on raised surfaces of the nano-patterned surface.

FIG. 8 is a transverse cross-section of the structure shown in FIG. 7.

FIG. 9 is a top plan view of the exemplary embodiment of the structure after lateral expansion of the domains on the nano-patterned surface.

FIG. 10 is a transverse cross-section of the structure shown in FIG. 9, which shows the domains partially covering regions of the nano-patterned surface defining recesses.

FIG. 11 is a top plan view of the exemplary embodiment of the structure after further lateral expansion of the domains on the nano-patterned surface, which shows the domains touching each other so as to form a continuous domain covering the entire nano-patterned surface.

FIG. 12 is a transverse cross-section of the structure shown in FIG. 11, which shows the domains completely covering the nano-patterned surface.

FIG. 13 is a transverse cross-section of an exemplary embodiment of a filament switching device including a self-assembled monolayer.

FIG. 14 is another transverse cross-section of the exemplary embodiment of the filament switching device including a self-assembled monolayer.

### DETAILED DESCRIPTION

Long-range ordered organic layers formed by self-assembled monolayer (SAM) techniques are provided. The ordered self-assembled monolayers can be used in various devices. The organic self-assembled monolayers can be used to form intermediate layers in the fabrication of device structures. The self-assembled monolayers can be formed with large domains, i.e., long-range order over a large region.

It has been determined that self-assembled monolayer structures can be formed on underlying surfaces that are without surface relief, i.e., on unpatterned surfaces. However, it has further been determined that the self-assembled monolayers formed on these unpatterned surfaces do not have sufficient long-range order of the molecules. In addition, these self-assembled monolayers typically form initially as island-like domains with depleted regions around adjacent domains and pinholes within domains, and form domain boundaries when neighboring islands grow together.

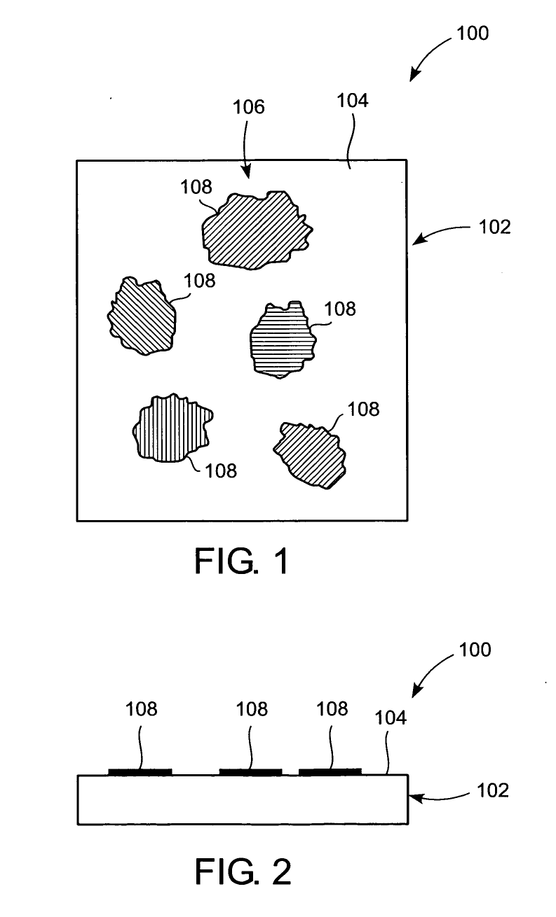

FIGS. 1-4 depict the progressive formation of an exemplary structure 100 including a substrate 102 having an unpatterned surface 104 and an organic self-assembled monolayer 106 formed on the unpatterned surface 104. As shown in FIGS. 1 and 2, the self-assembled monolayer 106 consists of domains 108 formed on the unpatterned surface 104. The domains 108 are randomly, spatially formed on the unpatterned surface 104 and have various sizes and shapes. The domains 108 are not ordered with respect to each other.

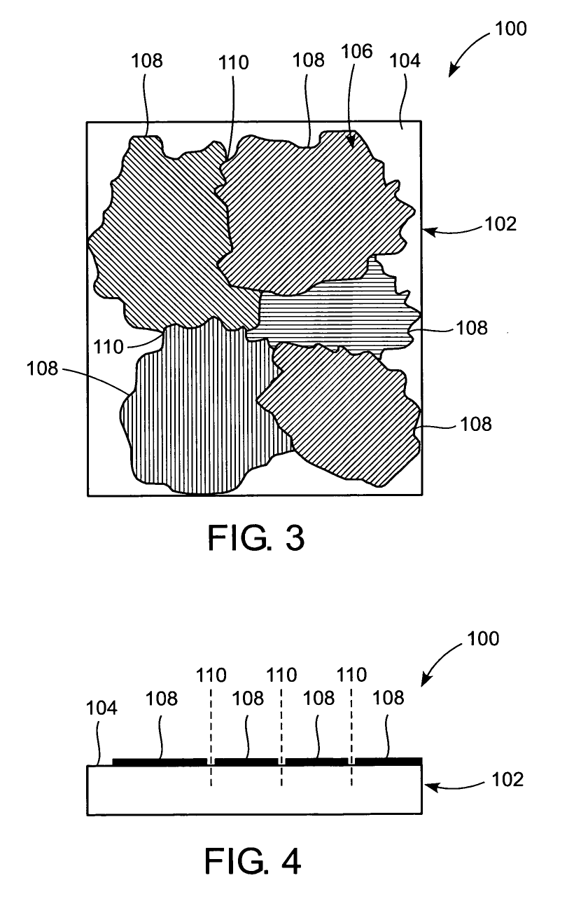

FIGS. 3 and 4 show the structure 100 following the lateral expansion of the domains 108 on the unpatterned surface 104 resulting from the further reaction of the organic precursor compound with the unpatterned surface 104. As shown, the domains 108 expand laterally on the unpatterned surface 104 in a random manner and adjacent domains 108 touch each other along random domain boundaries 110. These domain boundaries 110 disrupt the order in the self-assembled monolayer 106. The domains 108 formed on the unpatterned surface 104 typically have a domain size of, at most, several microns. The poor long-range surface coverage provided by the random, multi-domain structure depicted in FIGS. 1-4 is unsuitable for potential applications of self-assembled monolayers that require long-range ordering of organic molecules on a substrate surface.

The inventors determined that long-range, two-dimensional-ordered, polymerized self-assembled monolayers can be formed on substrates that have a nano-patterned surface. The self-assembled monolayers that can be formed are a single molecule thick and have in-plane order within the monolayer. The nano-patterned surfaces guide the formation of self-assembled monolayers of organic molecules that have long-range order over a large area on substrate surfaces. The self-assembled monolayers having long-range order can be formed with improved efficiency and have improved quality as compared to self-assembled monolayers formed on unpatterned surfaces. The self-assembled monolayers formed on the nano-patterned surfaces can be used, for example, to provide unique molecular properties to the performance characteristics of devices that include the self-assembled monolayers.

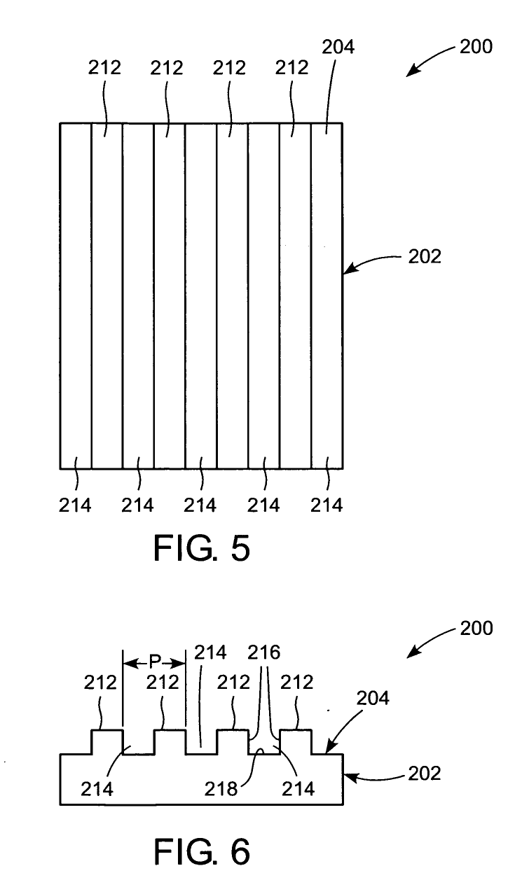

FIGS. 5-12 depict exemplary embodiments of a structure 200 including a substrate 202 having a nano-patterned surface 204 and an organic self-assembled monolayer 206 formed on the nano-patterned surface 204, i.e., the substrate 202 has nanometer-scale surface relief. As shown in FIGS. 5 and 6, in the exemplary embodiment, the substrate 202 comprises a nano-patterned surface 204 with features defined by raised surfaces 212 (for example, in the form of lines in this exemplary embodiment) separated from each other by recesses 214 across the width of the substrate 202. In the exemplary embodiment, the raised surfaces 212 are planar and extend longitudinally substantially in a common horizontal plane. In the exemplary embodiment, the recesses 214 have a trench configuration and are defined by vertical sidewalls 216 and a horizontal bottom surface 218.

As shown in FIG. 6, the illustrated features have a pitch, P. The pitch, P, of the features is preferably smaller than the domain size that forms on an unpatterned surface, such as the size of the domains 108 shown in FIGS. 3 and 4. The pitch, P, is preferably about 30 nm to about 1 μm, more preferably about 30 nm to about 200 nm. The pitch, P, can be variable in other embodiments of the substrate 202. The raised surfaces 212 have a width, W, of about 30 nm to about 100 nm, for example. The recesses 214 can have any suitable height, H (i.e., the dimension from the bottom surface 218 to the raised surface 212), such as about 2 nm to about 1 μm, for example, from about 2 nm to about 200 nm.

In other exemplary embodiments, the nano-patterned surface can have different patterns than the illustrated line pattern. For example, the sidewalls 216 of the recesses 214 formed in the nano-patterned surface can be tapered. In yet another exemplary embodiment, the pattern can form two-dimensional surface structures, such as rectangles, squares or the like.

The substrate 202 can be patterned by any suitable technique that provides the desired pattern, such as by use of nano-imprint lithography and reactive ion etching.

By forming a relief pattern in the substrate 202 that extends over a large area, the order in the self-assembled monolayer 206 formed on the substrate can similarly be extensive. In exemplary embodiments, the nano-patterned surface 204 of the substrate 202 can have a surface area of at least 1 μm², such as at least 10 μm², at least 100 μm², at least 1 cm², at least 100 cm², or even larger. Preferably, the self-assembled monolayer 206 covers substantially the entire nano-patterned surface 204 to provide a large-area ordered organic film that is suitable for applications that require longer-range order.

The substrate 202 can be composed of any suitable material that does not create order in the self-assembled monolayer 206 formed on the nano-patterned surface 204. The material of the substrate 202 can be selected based on the application of the structure 200. In an exemplary embodiment, the nano-patterned surface 204 is formed of an amorphous material. For example, the substrate 202 can be formed entirely of an amorphous material. Alternatively, the substrate 202 can have a surface region (for example, a top layer) of an amorphous material, and the underlying portion of the substrate 202 can be formed of a different material than the surface region. Suitable electrical insulator materials that can be used for the substrate 202 include, but are not limited to, SiO₂, Al₂O₃, Si₃N₄, and the like. The substrate 202 can alternatively be formed of an electrical conductor material selected from the group of semiconductor and metallic materials. For example, the substrate 202 can be formed of silicon, germanium or platinum.

In another exemplary embodiment, the nano-patterned surface of the substrate 202 on which the self-assembled monolayer is formed is comprised of two or more different materials, which form regions of the surface. For example, the surface can comprise regions formed of the first material and regions formed of the second material. The different materials forming the regions of the surface of the substrate 202 can be electrical conductors, electrical insulators, semiconductors, or combinations thereof.

In one exemplary embodiment, a first material can have a planar top surface, and a second material can be formed on the planar top surface of the first material. The first material can, for example, be a substrate. Alternatively, the first material can be a layer formed on a surface of another material. The second material can be formed, for example, as lines that are spaced from, and extend parallel to, each other on the planar top surface of the first material. The top surface of the lines can be co-planar.

In another exemplary embodiment, the first material can be a substrate or a layer formed on another material, and the second material can be embedded in the first material so that the top surface of the first material and the top surface of the second material are co-planar. For example, the second material can form lines on the first material.

For example, referring to FIG. 6, the raised portions of the substrate 202 above the horizontal bottom surfaces 218 (i.e., the portions of the substrate 202 defined by the raised surfaces 212 and the associated sidewalls 216) can be formed from a first material in the form of lines, as shown, and the surface of the substrate 202 underlying the first material can be formed from a different second material. In another exemplary embodiment, first and second materials can be formed on a common planar surface of a substrate, such that the top surface of the first material and the top surface of the second material are co-planar. Alternatively, the top surface of the first material and top surface of the second material can be non-co-planar. For example, lines of the first material and lines of the second material, respectively, can be formed on the planar surface of the substrate. The lines of the first and second materials can extend parallel to each other in an alternating pattern. The edges of the lines can touch each other to form a continuous layer of the first and second materials having a co-planar top surface, or alternatively a non-co-planar top surface.

Referring again to FIG. 6, in another exemplary embodiment, a first material can be formed on the raised surfaces 212 of the substrate 202, and a second material can be formed on the bottom surfaces 218. The second material can completely fill the recesses 214 (i.e., up to the height of the raised surfaces 212, such that the height of the filled recesses 214 is zero), or the second material can partially fill the recesses 214 (i.e., up to a height below the raised surfaces 212, such that the partially-filled recesses have a height that is greater than zero).

In an exemplary embodiment, a self-assembled monolayer can be formed on the first and second materials and bond to both materials. In another exemplary embodiment, a self-assembled monolayer may not bond to the first material (for example, gold), but bond to the second material (for example, SiO₂). As a result, the self-assembled monolayer that is formed on the first and second materials can be delaminated from the first material by sonication, for example, while the self-assembled monolayer remains bonded to the second material. For example, referring to FIG. 6, the first and second materials can be formed on the raised surfaces 212 and bottom surfaces 218, respectively, of the substrate 202, and the self-assembled monolayer can be delaminated from one of the first material and the second material so that only the raised surfaces 212 or the bottom surfaces 218 are covered by the self-assembled monolayer.

In an exemplary embodiment, the substrate 202 is formed of silicon having a native or chemically-formed oxide surface layer. In another exemplary embodiment, the substrate 202 is formed of silicon having a thick SiO₂ surface layer. For example, the SiO₂ surface layer can have a thickness of about 50 nm to about 500 nm. The SiO₂ surface layer typically is patterned only a portion of the way through its thickness (i.e., not all the way to the underlying material).

The self-assembled monolayer 206 formed on the nano-patterned surface can be fabricated from any suitable organic material. In an exemplary embodiment, the self-assembled monolayer 206 can be an alkylsiloxane monolayer derived from the reaction of an alkylsiloxane compound with the nano-patterned surface 204, such as SiO₂. For example, the self-assembled monolayer 206 can be formed from polymerizing octadecyltrichlorosilane (C₁₈H₃₇Cl₃Si; OTS). The alkylchlorosilane compound can be reacted with the nano-patterned surface by immersing the substrate into a solution containing the alkylsilane precursor and a suitable solvent. For example, the solution can contain octadecyltrichlorosilane as the chemical precursor in bicyclohexyl. Other solvents that can be used to form the solutions include, for example, toluene and chloroform. Other suitable polymerizing agents for forming the self-assembled monolayers on nano-patterned surfaces can be used in exemplary embodiments. Such polymerizing agents can include, for example, organo-phosphates, phosphonates, and various other classes of organosilane and organo-siloxanes.

The alkylsilane compound is reacted with the nano-patterned surface 204 for an amount of time that is effective to form an alkylsiloxane self-assembled monolayer 206 having ordered domains 208 that are spatially isolated from adjacent domains 208, or for a longer amount of time effective to form a continuous alkylsiloxane self-assembled monolayer 206 that covers substantially the entire nano-patterned surface. Typically, the solutions can be reacted with the nano-patterned substrates for about 5 min to about 24 hr, at a temperature of about 25° C. or less, to form a continuous self-assembled monolayer 206 that covers substantially the entire nano-patterned surface.

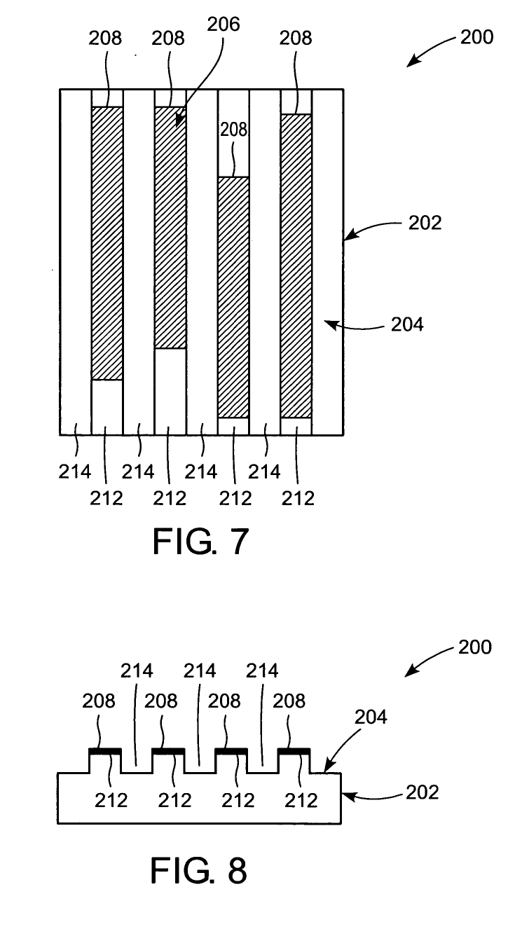

For a nano-patterned surface 204 formed of silicon, the inventors have demonstrated that the self-assembled monolayer 206 initially forms domains 208 on the raised surfaces 212, such as depicted in FIGS. 7 and 8. In contrast to the island-like domains 108 that form on an unpatterned surface 104 (see, for example, FIG. 4), the domains 208 formed on the nano-patterned surface 204 are ordered with respect to the features of the surface 204, and thus are also ordered with respect to each other.

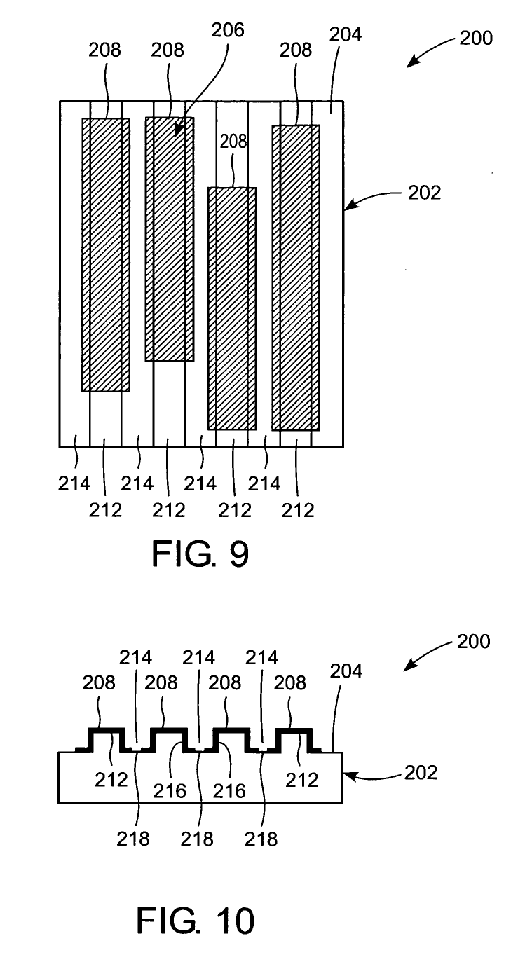

As depicted in FIGS. 9 and 10, continued reaction of the solution with the nano-patterned surface 204 causes the domains 208 to expand laterally in the recesses 214 and form on the side walls 216 and bottom surfaces 218 with continuing ordering of the self-assembled monolayer 208 with respect to the features of the nano-patterned surface 204.

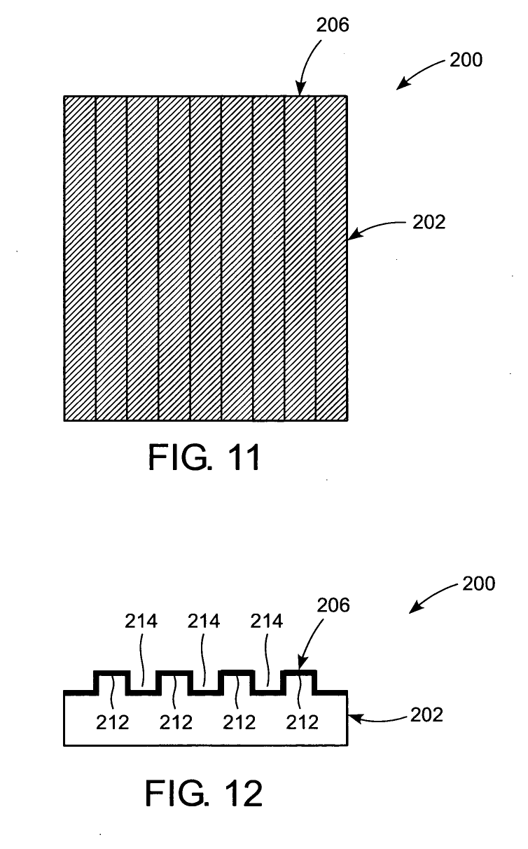

As depicted in FIGS. 11 and 12, with continued reaction of the solution with the nano-patterned surface 204, the domains 208 expand further laterally on the bottom surfaces 218 of the recesses 214 to touch each other and form a continuous self-assembled monolayer 206 covering the entire nano-patterned surface 204. The self-assembled monolayer 206 is a single molecule thick and has in-plane order within the monolayer. The self-assembled monolayer 206 is typically homogenous. Continuous coverage of the entire nano-patterned surface 204 of a substrate 202 by a self-assembled monolayer 206 has been demonstrated for silicon and SiO₂ (i.e., SiO₂ on Si) surfaces. The large-ordered domain minimizes domain boundaries, and can increase the potential range of device applications for which the self-assembled monolayer 206 can be used to those applications that require larger ordered regions.

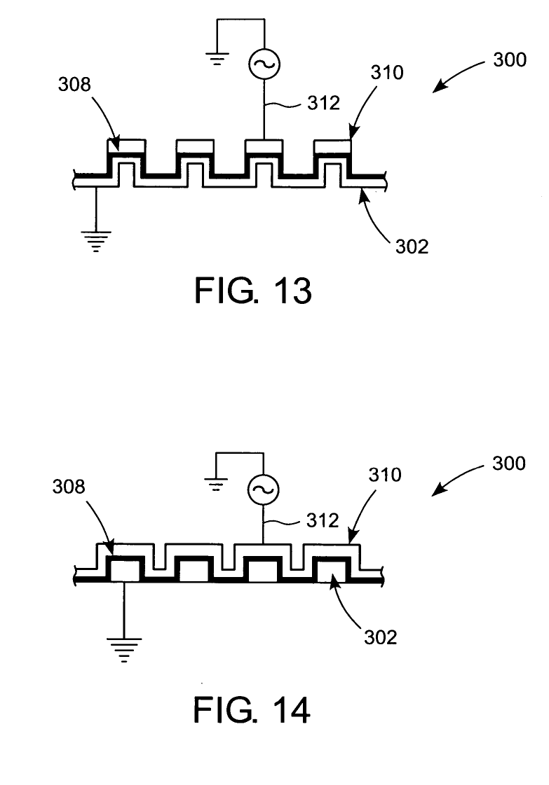

In an exemplary embodiment, the structures including a substrate having a nano-patterned surface and a self-assembled monolayer formed on the nano-patterned surface can be used in molecular electronics applications. FIGS. 13 and 14 depict an exemplary embodiment of a filament switching device 300 comprising a lower electrode 302 having a nano-patterned surface 304, an organic self-assembled monolayer 308 formed on the nano-patterned surface 304, and an upper electrode 310 formed on the self-assembled monolayer 308. A voltage source 312 is electrically connected to the lower electrode 302 and upper electrode 310. During operation of the filament switching device 300, the self-assembled monolayer 308 functions as a molecular switching layer. Although not being bound to any particular theory, it is contemplated that during operation of the filament switching device, metal ions are produced from the metal of the upper electrode 310 or the lower electrode 302. The metal ions migrate to the other of the upper electrode 310 or lower electrode 302, which creates a low-resistance path between the upper electrode 310 and lower electrode 302. The low-resistance path causes an increased current flow in the self-assembled monolayer 308 in the on-state of the filament switching device 300. In the off-state of the filament switching device 300, there is no current flow in the self-assembled monolayer 308.

The self-assembled monolayer 308 of the filament switching device 300 is preferably a continuous, long-range ordered layer having a substantially uniform thickness over the entire nano-patterned surface 304 of the lower electrode 302. The self-assembled monolayer 308 preferably contains few defects. Consequently, the self-assembled monolayer 308 preferably can minimize short circuits and enable more uniform switching properties during operation of the filament switch device 300.

The self-assembled monolayer 308 of the filament switching device 300 preferably has minimal domain boundaries, and the domain boundaries that it includes preferably have minimal defects. In contrast, self-assembled monolayers formed on unpatterned surfaces have random domain boundaries, which are electrically-weak regions with associated uncontrolled high electrical fields, low breakdown voltages, and a high density of short circuits. Accordingly, the long-range ordered, self-assembled monolayer 308 formed on the lower electrode 302 can at least reduce these problems associated with random domain boundaries.

The nano-patterned surface 304 of the lower electrode 302 can also controllably reduce the switching voltage of the filament switching device 300. Particularly, the nano-patterned surface 304 is an exemplary “rough” surface. The electric field is enhanced at convex regions on the nano-patterned surface 304. Consequently, the switching field can be reached at a lower applied voltage, making the device more compatible with conventional peripheral devices used to select and switch memory elements. For example, the switching voltage, Vₛ, may be given by the relationship: Vₛ=E_{local}·t, where E_{local} is the switching field and t is the switching layer thickness. The magnitude of the switching field, E_{local}, is much greater for a rough surface than for a smooth surface, such as an unpatterned surface. Consequently, for a fixed value of the switching field, E_{local}, the applied voltage for a rough surface, V_{applied, rough} is much smaller than the applied voltage for a rough surface, V_{applied, smooth}.

The lower electrode 302 and the upper electrode 310 of the filament switching device 300 can each be formed from any suitable materials. The material of the lower electrode 302 needs to be compatible with the material of the self-assembled monolayer 308 to allow formation of the self-assembled monolayer 308 on the nano-patterned surface 304. For example, the lower electrode 302 can be formed of metals, such as Al or Pt, or of semiconductor materials, such as silicon. The upper electrode 310 can be formed of any suitable metal that is compatible with the self-assembled monolayer 308 and the lower electrode 302, such as Ti. The upper electrode 310 can be of the same material, or a different material, than the lower electrode 302.

The lower electrode 302 can be formed by any suitable process and can have any suitable dimensions in the filament switching device 300. The lower electrode 302 can be patterned by any suitable technique, such as by lithography and dry etching techniques.

The self-assembled monolayer 308 can be of any suitable organic material that can be used to form a long-range ordered monolayer having minimal domain boundaries and defects. For example, the organic material can be an alkylsiloxane. The self-assembled monolayer 308 can be formed, for example, by immersing the lower electrode 302 in a solution containing the precursor that reacts with the nano-patterned surface 304 to form the self-assembled monolayer 308.

The upper electrode 310 can be formed on the self-assembled monolayer 308 by any suitable technique. For example, the upper electrode can be formed by an evaporation technique.

### EXAMPLES

Self-assembled monolayers are formed on unpatterned and nano-patterned substrates and evaluated. The substrates are four-inch, p-type (100)-oriented, silicon wafers having a thermally-grown, outer SiO₂ layer. The SiO₂ layer is patterned a portion of the way through its thickness using nanoimprint lithography and reactive ion etching. The nano-patterned surfaces have raised surfaces and recesses, such as that of the pattern depicted in FIGS. 5 and 6. The raised surfaces have a width of about 35 nm or about 90 nm with a pitch of about 200 nm. The recesses have a depth of about 12 nm to about 15 nm. The nano-patterned surface is highly hydrated. Typically, the oxide surface is hydrated primarily with Si—OH groups, which result from post-cleaning of the nano-patterned oxide surface.

Alkylsiloxane self-assembled monolayers are formed on the unpatterned and nano-patterned SiO₂ surfaces by immersing the substrates into a 10 mM solution containing n-octadecyltrichlorosilane (OTS) precursor and a solvent. The solutions are typically left to react with the unpatterned and nano-patterned SiO₂ surfaces for 5 min to 24 hr at a temperature of 25° C. or less. Typically, self-assembled monolayers that are formed on unpatterned surfaces under a dry inert condition (for example, less than about 1 ppm water) reach saturation coverage on the surfaces in about 24 hours. Typically, self-assembled monolayers that are formed on nano-patterned surfaces under such dry inert conditions reach saturation coverage on the surfaces in about 1 hour. Bicyclohexyl solutions are found to produce highly reproducible saturated monolayers.

Self-assembled monolayers are formed on the unpatterned and nano-patterned SiO₂ surfaces and characterized using the following techniques: X-ray photoelectron spectroscopy (XPS), attenuated total reflectance Fourier transform infrared spectroscopy (ATR-FTIR), thin-film elipsometry, contact-angle goniometry, and atomic force microscopy (AFM). Water contact angles are measured by contact-angle goniometry. The thickness and index of refraction of the SiO₂ layers are measured by thin-film elipsometry. The measured SiO₂ layer thickness is about 195 nm. The self-assembled monolayers formed on the unpatterned and nano-patterned SiO₂ surfaces have a typical measured thickness of about 2.5±0.2 nm. Atomic-force microscopy is used to obtain topographic images of the unpatterned and nano-patterned SiO₂ surfaces and the self-assembled monolayers formed on the surfaces.

The following is evaluated: (a) characteristics of self-assembled monolayers formed on unpatterned and nano-patterned SiO₂ surfaces for the same, limited time duration, and (b) characteristics of self-assembled monolayers formed on unpatterned and nano-patterned SiO₂ surfaces for a sufficiently long time period to form a “fully saturated” self-assembled monolayer on the surfaces.

To examine the influence of the underlying surface structure on the kinetics of self-assembled monolayer formation, unpatterned and nano-patterned SiO₂ surfaces are treated with OTS for limited time periods. Atomic-force micrographs of monolayers grown for 5 min show clear differences between the self-assembled monolayers formed on the unpatterned and nano-patterned SiO₂ surfaces. A 5 min deposition of OTS onto an unpatterned SiO₂ surface produces a partially-grown self-assembled monolayer with island-like domains with typical diameters ranging from about 300 nm to about 500 nm.

X-ray photoelectron spectroscopy is used to provide quantitative information about the surface coverage and efficiency of the two-dimensional polymerization of the molecules in the self-assembled monolayer domains formed on the unpatterned and nano-patterned SiO₂ surfaces. The spectra of saturated, self-assembled monolayers formed by reacting OTS for about 24 hr on unpatterned SiO₂ surfaces and for about 10 min on nano-patterned SiO₂ surfaces are determined. The self-assembled monolayers formed on the unpatterned and nano-patterned SiO₂ surfaces are fully cross-linked. The nano-patterned SiO₂ surfaces reacted with OTS for only a short duration exhibit characteristics that are qualitatively and quantitatively consistent with self-assembled monolayers reacted for 24 hr on unpatterned SiO₂ surfaces. The self-assembled monolayers formed on the nano-patterned SiO₂ surfaces lack observable domain boundaries and form a continuous film. These findings demonstrate that the nano-patterned SiO₂ surface strongly influences the kinetics and structural characteristics of the OTS self-assembled monolayer growth process.

Partially-saturated, self-assembled monolayers formed on unpatterned SiO₂ surfaces are evaluated. Island-like domains of two types are seen. Smaller islands have a diameter of about 50 nm to about 100 nm and larger domains have a diameter of about 300 nm to about 500 nm. At longer deposition times, the islands touch each other and form irregular boundaries. The domains include depleted zones around neighboring islands, defect sites and grain boundaries within islands, and domain boundaries between neighboring islands. The self-assembled monolayers formed on unpatterned SiO₂ surfaces also contain polysiloxane aggregate species. In contrast, self-assembled monolayers formed on nano-patterned SiO₂ surfaces exhibit uniformity over an area of more than 1 μm² (which was the area typically sampled), and are typically free of defects, and exhibit no polysiloxane aggregates on the raised surfaces or within the recesses of the patterned features.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A structure including a self-assembled monolayer, comprising:
a substrate including a nano-patterned surface; and
a self-assembled monolayer of an organic material on the nano-patterned surface, wherein the self-assembled monolayer is ordered with respect to features of the nano-patterned surface.

2. The structure of claim 1, wherein the substrate has a surface formed of an amorphous material.

3. The structure of claim 1, wherein the substrate is a crystalline material which does not create order in the self-assembled monolayer.

4. The structure of claim 1, wherein the substrate is formed of at least one material selected from the group consisting of electrical insulators, electrical conductors, semiconductors, and combinations thereof.

5. The structure of claim 1, wherein the substrate is formed of at least two different materials selected from the group consisting of electrical insulators, electrical conductors, semiconductors, and combinations thereof.

6. The structure of claim 1, wherein the features of the nano-patterned surface have a pitch of about 30 nm to about 1 μm.

7. The structure of claim 1, wherein the self-assembled monolayer is continuous, has a surface area of about 1 μm² to 100 cm² and is substantially free of disordered domain boundaries.

8. The structure of claim 1, wherein the features comprise raised surfaces separated by recesses, and the self-assembled monolayer covers the raised surfaces, the recesses, or the raised surfaces and the recesses.

9. The structure of claim 1, wherein the polymer material is an alkylsiloxane.

10. The structure of claim 1, wherein:
the substrate includes at least a first surface region of a first material and a second surface region of a second material; and
the self-assembled monolayer of the organic material is formed on at least one of the first region and the second region, wherein the self-assembled monolayer is ordered with respect to features of the at least one of the first surface region and the second surface region.

11. A filament switching device, comprising:
a lower electrode having a nano-patterned surface;
a self-assembled monolayer of an organic material formed on the nano-patterned surface, wherein the self-assembled monolayer is ordered with respect to features of the nano-patterned surface; and
an upper electrode formed on the self-assembled monolayer.

12. The filament switching device of claim 11, wherein:
the lower electrode is formed of a first metal or a semiconductor material;
the organic material is an alkylsiloxane; and
the upper electrode is formed of a second metal.

13. The filament switching device of claim 11, wherein the features of the nano-patterned surface have a pitch of about 30 nm to about 1 μm.

14. The filament switching device of claim 11, wherein the self-assembled monolayer is continuous, has a surface area of about 1 μm² to about 100 cm² and is substantially free of disordered domain boundaries.

15. The filament switching device of claim 14, wherein the features comprise raised surfaces separated by recesses, and the self-assembled monolayer covers the raised surfaces, the recesses, or the raised surfaces and the recesses.

16. The filament switching device of claim 11, wherein the self-assembled monolayer is formed from an alkylsiloxane.

17. A method of making a structure including a self-assembled monolayer, the method comprising forming a self-assembled monolayer of an organic material on a nano-patterned surface of a substrate, wherein the self-assembled monolayer is ordered with respect to features of the nano-patterned surface.

18. The method of claim 17, wherein the features of the nano-patterned surface have a pitch of about 30 nm to about 1 μm.

19. The method of claim 17, wherein the self-assembled monolayer is continuous, has a surface area of about 1 μm² to about 100 cm² and is substantially free of disordered domain boundaries.

20. The method of claim 17, wherein the features comprise raised surfaces separated by recesses, and the self-assembled monolayer covers the raised surfaces, the recesses, or the raised surfaces and the recesses.
